(19) United States
(12) Patent Application Publication
(10) Pub. No.: US 2011/0167216 A1
(43) Pub. Date: Jul. 7, 2011

(54) Redundant array of independent disks system

(75) Inventors: Cheng-Yi Huang, Hsin-Chu City (TW); Shin-Ping Lin, Zhubei City (TW)

(73) Assignee: PROMISE TECHNOLOGY, INC., Hsin-Chu (TW)

(21) Appl. No.: 12/656,864

(22) Filed: Feb. 18, 2010

(30) Foreign Application Priority Data
Jan. 6, 2010 (TW) 099100151

(51) Int. Cl. G06F 12/16; G06F 11/20

(52) U.S. Cl. 711/114; 711/E12.103; 714/E11.101

(57) ABSTRACT

A Redundant Array of Independent Disks (RAID) system is disclosed in this invention. The RAID system includes a plurality of data storage units and a parity storage medium. The parity storage medium can be singular storage hardware or a logical storage module including multiple storage units. The parity storage medium cooperates with the data storage units to form a RAID. The parity storage medium is used for storing parity information of the RAID. A first write speed of the parity storage medium is faster than a second write speed of each data storage unit.

### BACKGROUND OF THE INVENTION

1. Field of the Invention

The invention relates to a redundant array of independent disks (RAID) system, and more particularly to a RAID system with faster random write speed.

2. Description of the Prior Art

In the digital era nowadays, kinds of data in daily life (e.g. documents, file records, letters, personal information and some multimedia) are usually digitalized. Many important files of personal information, business records or even governmental papers are stored and exchanged depending on some electronic systems. However, the digital storage device in a common personal computer only depends on singular hard drive in most situations. Singular hard drive has some boundary in capacity, and also the access speed of singular hard drive is limited because of some hardware specifications (e.g. read-write head structure, disk rotation speed, or bus bandwidth). Besides, singular hard drive is lack for stability and durability when it goes through electricity-failures or attacks from hackers and viruses.

In practical applications, there are many basic and advanced types of storage devices, e.g. the Redundant Array of Independent Disks (RAID) system with mirror-storing function and file-recovering function. The RAID system may utilize an independent RAID controller and some specific algorithms to backup important documents. Accordingly, the RAID system may provide more capacity, better security, faster access speed, and emergency recovering function for damaged files.

Recently, the RAID systems are widely applied in the government, financial business and personal applications. In order to match different demands (e.g. large space, high speed, high space efficiency and data safety) in different applications, various types of the RAID systems are designed.

At first, the RAID-1 structure adopts mirroring way to storing information. It duplicates all data of the original data hard drive into a mirror hard drive. The RAID-1 structure may provide high security but poor space efficiency (only 50% in this case). Besides, the write speed of the RAID-1 structure is not faster than one singular hard drive. To achieve the file recovering function and remain high space efficiency, the RAID system usually utilizes a specific storage unit for recording an error detecting code. For example, the error detecting code applied in RAID-3 and RAID-4 structure is a set of parity check information based on odd/even parity check, e.g. parity bit or parity block.

Take a RAID system (RAID-3 or RAID-4 structure) with four hard drives for example, one of the four hard drives can be assigned to the parity hard drive, and the other threes can serve as the data drive drives. The RAID-3 or RAID-4 system may utilize the parity hard drive to store the parity check code for emergency data recovering. When one of the data hard drives suffers some damage, the data in the damaged hard drive can be restored according the parity hard drive and other data hard drives. Besides, the space efficiency under RAID-3 or RAID-4 structure is better than RAID-0 structure.

The RAID system in RAID-3 or RAID-4 structure performs well in sequential write, sequential read, and random read procedure. However, the overall random write speed of the RAID system (RAID-3 or RAID-4) is limited by the write speed of the parity hard drive.

In comparison, there is another RAID structure, RAID-5, which adopt a rotating distribution of its parity check code. In other words, the parity check code in RAID-5 structure is equally allocated into each hard drive. The RAID-5 structure with proper write-in procedure management may achieve a faster random write speed. However, the parity check code in RAID-5 is spread into every hard drives. In this way, the parity information in RAID-5 is hard to manage, and the algorithms for data access and recovery are much more complex. Besides, the implementation and maintenance cost of the RAID-5 is higher as well.

The invention disclose a RAID system, which adopt a high-speed physical hard drive as a parity storage unit, or it built up a sub-RAID to serve as a high-speed logical parity storage module, so as to solve the aforesaid problems.

### SUMMARY OF THE INVENTION

A scope of the invention is to provide a redundant array of independent disks (RAID) system.

According to an embodiment, the RAID system includes a plurality of data storage units and a parity storage unit. The parity storage unit cooperates with the data storage units to form a RAID. The parity storage unit is used for storing parity check information of the RAID. A first write speed of the parity storage unit is faster than a second write speed of each data storage unit.

According to another embodiment, the RAID system includes a plurality of data storage units and a parity storage module. The parity storage module cooperates with the data storage units to form a first RAID. The parity storage module is used for storing parity check information of the first RAID. The parity storage module includes a plurality of parity storage units. The parity storage units of the parity storage module form a second RAID. A first write speed of the whole parity storage module is faster than a second write speed of each data storage unit.

Compared to prior art, the RAID system in the invention adopts one singular physical storage medium as a parity storage unit, or it may adopt a sub-RAID with multiple storage media as a logical parity storage module. Accordingly the write speed of parity storage medium can be faster than each of other data storage media. In this way, the RAID system in the invention has lower implementation cost and faster random write speed.

The advantage and spirit of the invention may be understood by the following recitations together with the appended drawings.

### BRIEF DESCRIPTION OF THE APPENDED DRAWINGS

FIG. 1 is a schematic diagram illustrating a RAID system according to a first embodiment of the invention.

FIG. 2 is a schematic diagram illustrating a RAID system according to a second embodiment of the invention.

### DETAILED DESCRIPTION OF THE INVENTION

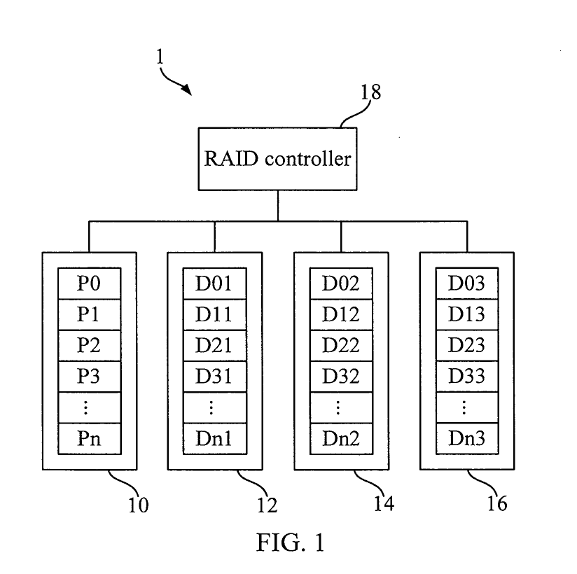

Please refer to FIG. 1. FIG. 1 is a schematic diagram illustrating a RAID system 1 according to a first embodiment of the invention. As shown in FIG. 1, the RAID system 1 includes a parity storage unit 10, a plurality of data storage units and a RAID controller 18. In this embodiment, the RAID system 1 includes three data storage units (12, 14, and 16), but the invention is not limited to this. In practical application, the total amount of the data storage unit in the RAID system 1 can be adjusted according to space demand, implementation budget, application purpose, etc. It is well known by a skilled person in the art. The RAID controller 18 is coupled to the parity storage unit 10 and the data storage units (12, 14, and 16) respectively. The RAID controller is used to execute the instructions for reading from or writing into aforesaid storage units.

As the case in FIG. 1, each of the parity storage unit 10 and the data storage units (12, 14, and 16) can be a hard drive. The parity storage unit 10 can cooperate with the data storage units to form a RAID. In the embodiment, the RAID formed by the parity storage unit 10 and the data storage units may adopt a RAID-3 structure based on a bit-interleaving technology, or adopt a RAID-4 structure based on a block-interleaving technology.

Under the RAID-3 and RAID-4 structure, files and documents are stored in to three data storage units (12, 14 and 16). The parity storage unit 10 is used for storing parity check information (e.g. the parity check code P0˜Pn in FIG. 1) for data recovery. In practical applications, the parity information can be a parity bit or a parity block. As the example in FIG. 1, the parity check code P0 stored in the parity, storage unit 10 is used for corresponding to the file data D01 in the data storage unit 12, the file data D02 in the data storage unit 14, and the file data D03 in the data storage unit 16.

Equivalently, each parity check code Px in the parity storage unit 10 may correspond to the file data Dx1, Dx2 and Dx3 in the data storage units, for 0≦x≦n.

When one of the data storage units suffers some damage on its hard drive, the data in the damaged data storage unit can be restored according the parity storage unit 10 and other data storage units. Besides, the space efficiency of the RAID system 1 (about 75% in this case) is better than the RAID-1 structure. On the other hand, when the hard drive of the parity storage unit 10 is damaged, the hard disk of the parity storage unit 10 can be replaced easily. Afterward, the parity check code can be regenerated and stored into the parity storage unit 10 after replacement.

In a traditional RAID-3 or RAID-4 system, it has a poor write speed performance in random write procedure. It is because that each time when a file data is written into the data storage units in the RAID-3 or RAID-4 system, the RAID-3 or RAID-4 system needs to modify one corresponding parity check code in the parity storage unit 10.

For example, when there is a request to write into the file data D11 of the data storage unit 12, the parity check code P1 may need to be modified at the same time; on the other hand, when there is a request to write into the file data D32 of the data storage unit 14, the parity check code P3 may need to be modified at the same time. In this way, each random write procedure needs to modify the parity storage unit 10. Therefore, only one random write procedure can be executed in one time slot.

In other words, in aforesaid random write procedure, there are only two hard drives (the parity storage unit 10 and one of the data storage units) working in one time slot, and the other two data storage units are idle.

Therefore, the overall write speed of the RAID system with the RAID-3 and RAID-4 structure is mainly affected by the write speed of the parity storage unit 10.

To solve aforesaid problem, the RAID system 1 in the invention adopt a high-speed storage medium to serve as the parity storage unit 10. For example, the parity, storage unit 10 in this embodiment can be a Solid State Drive (SSD). The SSD drive is well known by its fast read/write speed and high vibration durability. However; the present SSD drive cost a lot and cost more than other types of hard drives. To implement the whole RAID system with SSD drives (total four hard drives) is against budget efficiency. The RAID system in this embodiment only adopts one SSD drive as the parity storage unit 10, for boosting the random access speed of whole RAID system 1.

Approximate write speeds of commercial available storage media are listed in the following Table 1.

TABLE 1

| Storage Hardware | Random Write Speed | |
|---|---|---|
| SSD drive | 100 | MB/sec |
| SAS drive (15000 rpm) | 80 | MB/sec |
| SAS drive (10000 rpm) | 50 | MB/sec |
| SATA drive (10000 rpm) | 40 | MB/sec |
| SATA drive (7200 rpm) | 30 | MB/sec |
| SATA drive (5400 rpm) | 20 | MB/sec |

As shown in Table 1, if the parity storage unit 10 adopts the SSD drive with relative high speed, it can reach 3-5 times write speed compared to a regular high capacity SATA drive.

However, the parity storage unit 10 of the invention is not limited to the SSD drive. In practical application, the parity storage unit 10 can also be a Serial Attached SCSI (SAS) drive or a Serial Advanced Technology Attachment (SATA) drive. In other words, when the first write speed of the parity storage unit 10 is faster than the second write speed of each data storage unit (e.g. high-capacity SATA drive), the random write speed of whole RAID system 1 can be elevated, without replacing all storage media in the RAID system 1 with expensive SSD drives or some high rotating-speed hard drives, so as to prevent the implementation cost of the RAID system 1 from boosting.

In aforesaid embodiment, the parity storage unit 10 in the RAID system 1 adopts one singular physical hard drive to serve as a high-speed storage medium. However, the invention is not limited to this. In another embodiment, the RAID system may utilize multiple hard drives to form a sub-RAID. The sub-RAID serves as a logical high-speed parity storage module.

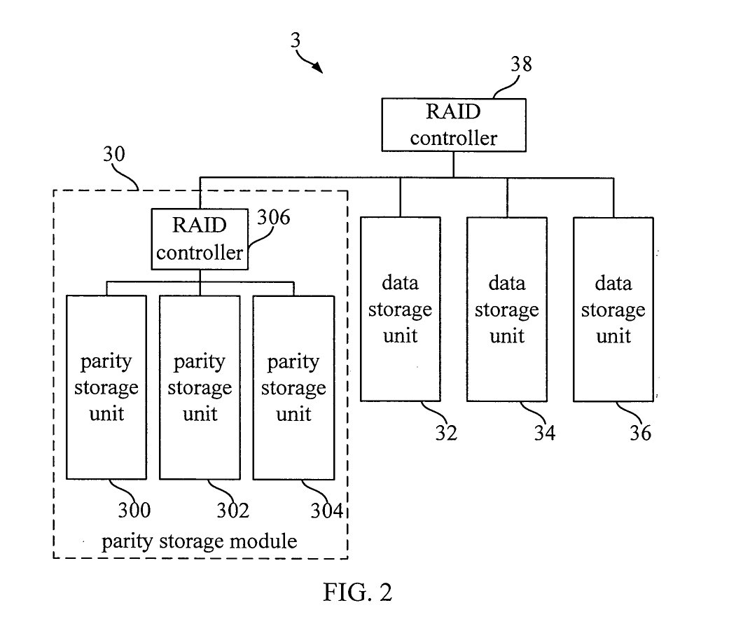

Please refer to FIG. 2. FIG. 2 is a schematic diagram illustrating a RAID system 3 according to a second embodiment of the invention. In the RAID system 3 shown in FIG. 2, the RAID system 3 includes a parity storage module 30, three data storage units (32, 34 and 36) and a RAID controller 38. The parity storage module 30, the data storage unit 32, the data storage unit 34 and the data storage unit 36 form a first RAID. The first RAID may adopt a RAID-3 structure based on a bit-interleaving technology or adopt a RAID-4 structure based on a block-interleaving technology. The structure of the first RAID is similar to the first embodiment of the invention, so not to be repeated here again.

The main difference from the first embodiment is that, the parity storage module 30 in the second embodiment includes a plurality of parity storage units. In the case shown in FIG. 2, the parity storage module 30 includes three parity storage units (300, 302 and 304). Besides, the parity storage module 30 may further include another RAID controller 306 coupled to the parity storage units (300, 302 and 304). These three parity storage units (300, 302 and 304) form a second RAID.

In aforesaid embodiment, the parity storage module 30 includes an independent RAID controller 306, but the invention is not limited to this. In another embodiment, the RAID controller 306 and the RAID controller 38 can be integrated into one process chip. In other cases, the RAID controller 306 and the RAID controller 38 can be implemented with a specific software control program or firmware control program. The controlling method and software/hardware structure of the RAID controller is well known by a skilled person in the art, so not to be mentioned here.

To be noticed that, parity check information of the first RAID is stored in the second RAID formed by the parity storage units (300, 302 and 304). In other words, the first RAID of the invention utilizes the second RAID (including the parity storage units 300, 302 and 304) to serve as a logical parity storage module 30.

The second RAID may adopt a RAID-0 structure based on a data-stripping technology. Under the RAID-0 structure, the second RAID has no redundant recovery function. The second RAID divides input files or data into N pieces (3 pieces in this case) and store them into the parity storage units (300, 302 and 304). In this way, the write speed of the second RAID may achieve approximately three times as fast as singular storage hardware.

Take this embodiment for example, when the parity storage module 30 includes three parity storage units. The overall write speed of the parity storage module 30 is approximately three times as fast as the individual write speed of each parity storage unit. In other words, when the second RAID includes N parity storage units, the first write speed of the whole parity storage module is substantially N times as fast as a second write speed of each data storage unit, wherein the parameter “N” depends on the total amount of the parity storage units. In this way, the first write speed of the whole parity storage module 30 can be far faster than the second write speed of each of the data storage units (32, 34 or 36), so as to elevate the random write speed of the RAID system 3.

In this invention, the total amount of the parity storage units in the parity storage module 30 is not limited to three. However, it depends on the demand to the overall random write speed in practical application.

In this embodiment, each parity storage unit can be a SSD drive, a SAS drive, a SATA drive or an Integrated Device Electronics (IDE) drive.

Besides, the second RAID is not limited to adopt the RAID-0 structure. In another embodiment, the second RAID may adopt a Just a Bunch of Disks (JBOD) structure based on a logical volume integration technology.

In practical applications, if the SSD drive is implemented as a parity storage unit, it may provide faster write speed but less storage capacity. There is no commercial available SSD drive which has comparable capacity relative to other types of hard drives (e.g. SATA drive or IDE drive). In this invention, multiple SSD drives can be combined in a JBOD structure to form the parity storage module 30, such that the total storage capacity of the parity storage module 30 is equal to the sum of all SSD drives. In this way, the storage capacitor issue of the SSD drives can be solved.

In summary, the RAID system in the invention adopts one singular physical storage medium as a parity storage unit, or it may adopt a sub-RAID with multiple storage media as a logical parity storage module. Accordingly the write speed of parity storage medium can be faster than each of other data storage media. In this way, the RAID system in the invention has lower implementation cost and faster random write speed.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A redundant array of independent disks (RAID) system, comprising:
a plurality of data storage units; and
a parity storage unit, the parity storage unit cooperating with the data storage units to form a RAID, the parity storage unit being used for storing parity check information of the RAID, a first write speed of the parity storage unit being faster than a second write speed of each data storage unit.

2. The RAID system of claim 1, wherein the parity storage unit is a Solid State Drive (SSD), a Serial Attached SCSI (SAS) drive or a Serial Advanced Technology Attachment (SATA) drive.

3. The RAID system of claim 1, wherein the RAID adopts a RAID-3 structure based on a bit-interleaving technology.

4. The RAID system of claim 1, wherein the RAID adopts a RAID-4 structure based on a block-interleaving technology.

5. A redundant array of independent disks (RAID) system, comprising:
a plurality of data storage units; and
a parity storage module, the parity storage module cooperating with the data storage units to form a first RAID, the parity storage module being used for storing parity check information of the first RAID, the parity storage module comprising a plurality of parity storage units, the parity storage units of the parity storage module forming a second RAID, a first write speed of the whole parity storage module being faster than a second write speed of each data storage unit.

6. The RAID system of claim 5, wherein the first RAID adopts a RAID-3 structure based on a bit-interleaving technology.

7. The RAID system of claim 5, wherein the first RAID adopts a RAID-4 structure based on a block-interleaving technology.

8. The RAID system of claim 5, wherein the second RAID adopts a RAID-0 structure based on a data-stripping technology.

9. The RAID system of claim 8, wherein when the second RAID includes N parity storage units, the first write speed of the whole parity storage module is substantially N times as fast as a second write speed of each data storage unit.

10. The RAID system of claim 8, wherein each parity storage unit of the parity storage module is a Solid State Drive (SSD), a Serial Attached SCSI (SAS) drive, a Serial Advanced Technology Attachment (SATA) drive or an Integrated Device Electronics (IDE) drive.

11. The RAID system of claim 5, wherein the second RAID adopts a Just a Bunch of Disks (JBOD) structure based on a logical volume integration technology.

12. The RAID system of claim 11, wherein each parity storage unit of the second RAID is Solid State Drive (SSD).
